(19) United States
(12) Patent Application Publication
(10) Pub. No.: US 2025/0172949 A1
(43) Pub. Date: May 29, 2025

(54) GOODS DELIVERY SYSTEM AND METHOD USING UNMANNED DELIVERY ROBOT

(71) Applicant: RGT Inc., Seoul (KR)

(72) Inventor: Hojeong JEONG, Daejeon (KR)

(73) Assignee: RGT Inc., Seoul (KR)

(21) Appl. No.: 18/902,402

(22) Filed: Sep. 30, 2024

(30) Foreign Application Priority Data
Nov. 29, 2023 (KR) 10-2023-0169559

(51) Int. Cl. G05D 1/667; G05D 1/69; G05D 105/28

(52) U.S. Cl. CPC G05D 1/667; G05D 1/69; G05D 2105/28

(57) ABSTRACT

Provided are a goods delivery system and method using an unmanned delivery robot. A goods delivery system using an unmanned delivery robot according to various embodiments of the present invention includes an unmanned delivery robot placed within a predetermined space and a server that controls an operation of the unmanned delivery robot, in which the server controls the operation of the unmanned delivery robot based on delivery information for the predetermined space to allow goods corresponding to the delivery information to be delivered to a delivery point through the unmanned delivery robot.

### CROSS-REFERENCE TO RELATED APPLICATION

This application claims priority to and the benefit of Korean Patent Application No. 2023-0169559, filed on Nov. 29, 2023, the disclosure of which is incorporated herein by reference in its entirety.

### BACKGROUND

### 1. Field of the Invention

Various embodiments of the present invention relate to a goods delivery system and method using an unmanned delivery robot.

### 2. Discussion of Related Art

Delivery service is a service in which people and companies directly deliver packaged products and goods to requested locations. The delivery service is generally provided in domestic areas, but international logistics companies sometimes handle international delivery goods.

In particular, due to social distancing for COVID-19 prevention, the amount of delivery goods has increased significantly compared to the past, which puts a great burden on delivery workers. Recently, there are cases where delivery workers die from overwork. Since all the assigned delivery goods should be delivered on a given day, the delivery workers should work till late at night, which resulted in various side effects.

In addition, there are cases where customers do not want the delivery workers to come directly to delivery addresses of the customers for reasons such as security, and there are actual cases where the delivery workers are accused of trespassing.

To prevent these, other methods of delivering goods are being studied and commercialized. Although not yet commercialized, a method of delivering goods using drones is being developed, and a method of delivering goods using a robot, etc., is also being devised.

However, in the conventional method, for example, in the case of delivering goods using a drone, there is a limit to a weight of goods that the drone can lift, and it is not easy to apply the method of delivering goods using a drone to move goods to predetermined locations in a building.

Therefore, a new autonomous goods delivery system, which is capable of delivering goods autonomously without manpower while maintaining security and reducing labor of a delivery worker, and an autonomous goods delivery method thereof are required.

### SUMMARY OF THE INVENTION

The present invention is directed to providing a goods delivery system and method using an unmanned delivery robot capable of reducing a burden on a delivery worker due to delivery work and more efficiently performing delivery work by placing an unmanned delivery robot in a predetermined space such as a large building or an apartment complex and performing goods delivery work using the unmanned delivery robot.

Objects of the present invention are not limited to the above-mentioned objects. That is, other objects that are not mentioned may be obviously understood by those skilled in the art from the following description.

According to an aspect of the present invention, there is provided a goods delivery system using an unmanned delivery robot including an unmanned delivery robot placed in a predetermined space, and a server that controls an operation of the unmanned delivery robot, in which the server may control the operation of the unmanned delivery robot based on delivery information for the predetermined space to allow goods corresponding to the delivery information to be delivered to a delivery point through the unmanned delivery robot.

When the server acquires delivery information including information about one or more goods scheduled to be delivered to the predetermined space and information about a delivery person for delivering the one or more goods from a goods delivery company server, the server may generate a delivery task for the one or more goods based on the acquired delivery information, and when the delivery person for delivering the one or more goods enters the predetermined space, the server may generate a control command according to the generated delivery task, and control the operation of the unmanned delivery robot according to the generated control command.

The server may control the operation of the unmanned delivery robot according to the generated control command, measure a weight value of goods loaded onto the unmanned delivery robot through a weight measurement sensor included in the unmanned delivery robot, determine whether the goods loaded onto the unmanned delivery robot match goods corresponding to the generated delivery task based on the measured weight value, and when the goods loaded onto the unmanned delivery robot do not match the goods corresponding to the generated delivery task, perform control to output a notification guiding a confirmation of the goods through an output module included in the unmanned delivery robot.

When the server acquires delivery information from a specific delivery person who enters the predetermined space, the server may generate a control command according to the acquired delivery information and control the operation of the unmanned delivery robot according to the generated control command.

The server may determine the number of unmanned delivery robots to be controlled based on attributes of the goods to be delivered included in the acquired delivery information, in which the attributes of the goods may include at least one of the number, type, delivery point, weight, and size of the goods.

When specific goods are delivered to a specific delivery point based on the acquired delivery information, the server may control a first unmanned delivery robot to deliver the specific goods to the specific delivery point through the first unmanned delivery robot, and when there is a second unmanned delivery robot moving to the specific delivery point based on a pre-generated delivery task, the server may control the first unmanned delivery robot to deliver the specific goods to the second unmanned delivery robot and then return to a preset return point.

When goods are delivered to a plurality of different delivery points using one unmanned delivery robot based on the acquired delivery information, the server may generate a movement path connecting the plurality of different delivery points based on at least one of a movement time and a movement distance, and control the one unmanned delivery robot to move along the generated movement path.

When the server determines that inter-floor movement via an elevator is necessary based on the generated movement path, the server may transmit a control request requesting to control an operation of the elevator to an elevator control server for controlling the elevator at a time at which the unmanned delivery robot arrives at the elevator.

When specific goods are delivered to a specific delivery point based on the acquired delivery information, the server may determine whether a recipient of the specific goods is absent based on location information acquired from a terminal of the recipient of the specific goods, and when it is determined that the recipient of the specific goods is absent, the server may control the unmanned delivery robot to deliver the specific goods from the recipient of the specific goods to a preset consignment delivery point.

The unmanned delivery robot may include a weight measurement sensor that measures a weight value of the goods loaded onto the unmanned delivery robot, and when the change in weight value is detected based on the weight value measured by the weight measurement sensor after the unmanned delivery robot arrives at the delivery point, the server may control the unmanned delivery robot so that the unmanned delivery robot returns to a preset return point.

When the change in weight value exceeding the weight value of the specific goods is detected through the weight measurement sensor included in the specific unmanned delivery robot that has moved to the specific delivery point to deliver the specific goods, the server may control a warning notification to be output through the output module included in the specific unmanned delivery robot.

When no change in weight value is detected until a reference time has elapsed through the weight measurement sensor included in the specific unmanned delivery robot that has moved to the specific delivery point to deliver the specific goods, the server may control the specific unmanned delivery robot to return to the preset return point.

According to another aspect of the present invention, there is provided a goods delivery method using an unmanned delivery robot, which is performed by a goods delivery system including an unmanned delivery robot arranged in a predetermined space and a server for controlling an operation of the unmanned delivery robot, includes acquiring, by the server, delivery information for the predetermined space, and controlling, by the server, the operation of the unmanned delivery robot based on the acquired delivery information to allow goods corresponding to the delivery information to be delivered to a delivery point through the unmanned delivery robot.

Other detailed contents of the present invention are described in a detailed description and are illustrated in the drawings.

### BRIEF DESCRIPTION OF DRAWINGS

The above and other objects, features and advantages of the present invention will become more apparent to those of ordinary skill in the art by describing exemplary embodiments thereof in detail with reference to the accompanying drawings, in which:

FIG. 1 is a diagram illustrating a goods delivery system using an unmanned delivery robot according to an embodiment of the present invention;

FIGS. 2 and 3 are diagrams exemplarily illustrating an unmanned delivery robot applicable to various embodiments;

FIG. 4 is a diagram illustrating a hardware configuration of a server according to another embodiment of the present invention;

FIG. 5 is a flowchart for describing a goods delivery method using an unmanned delivery robot according to a first embodiment;

FIG. 6 is a flowchart for describing a process of controlling the unmanned delivery robot to deliver goods according to the first embodiment;

FIG. 7 is a flowchart for describing a goods delivery method using an unmanned delivery robot according to a second embodiment;

FIG. 8 is a flowchart for describing a process of controlling the unmanned delivery robot to deliver goods according to the second embodiment;

FIGS. 9A to 9C are diagrams for describing various forms of controlling an operation of the unmanned delivery robot according to a pre-generated delivery task in various embodiments; and

FIG. 10 is a diagram for describing a configuration for moving an elevator by transmitting an elevator control request to an elevator control server, when inter-floor movement is required, in various embodiments.

### DETAILED DESCRIPTION OF EXEMPLARY EMBODIMENTS

Advantages and features of the present invention and methods to achieve them will be elucidated from exemplary embodiments described below in detail with reference to the accompanying drawings. However, the present invention is not limited to embodiments to be described below, but may be implemented in various different forms, these embodiments will be provided only in order to make the present invention complete and allow those skilled in the art to completely recognize the scope of the present invention, and the present invention will be defined by the scope of the claims.

As used herein, the terms are for describing embodiments rather than limiting the present invention. Unless explicitly described to the contrary, a singular form includes a plural form in the present specification. Terms “comprise” and/or “comprising” used in the present invention do not exclude the existence or addition of one or more other components other than the mentioned components.

Like reference numerals refer to like components throughout the specification and “and/or” includes each of the components mentioned and includes all combinations thereof. The terms “first,” “second,” and the like are used to describe various components, but these components are not limited by these terms. These terms are used only in order to distinguish one component from other components. Accordingly, a first component mentioned below may be a second component within the technical spirit of the present invention.

Further, as used herein, the term “unit” or “module” means a hardware component such as software, FPGA, or ASIC and performs predetermined functions. However, the term “unit” or “module” is not meant to be limited to software or hardware. A “unit” or “module” may be configured to be stored in a storage medium that can be addressed or may be configured to regenerate one or more processors. Accordingly, for example, the “unit” or “module” includes components such as software components, object-oriented software components, class components, and task components, processors, functions, attributes, procedures, subroutines, segments of a program code, drivers, firmware, a microcode, a circuit, data, a database, data structures, tables, arrays, and variables. Functions provided in components, “units,” or “modules” may be combined into fewer components, “units,” or “modules” or further separated into additional components, “units,” or “modules.”

Spatially relative terms “below,” “beneath,” “lower,” “above,” “upper,” and the like, may b be used in order to easily describe correlations between one component and other components. The spatially relative terms should be understood as terms including different directions of components during use or operation in addition to the directions illustrated in the drawings. For example, in a case of overturning component illustrated in the drawings, a component described as “below” or “beneath” another component may be placed “above” the other component. Accordingly, an illustrative term “below” may include both of a downward direction and an upward direction. Components may be oriented in other directions as well, and thus, spatially relative terms may be interpreted according to orientations.

Unless the context dictates otherwise, as used herein, the expressions such as “first,” “second,” or “1st” or “2nd” are used to distinguish one object from another when referring to a plurality of objects of the same type and do not limit the order or importance of the objects in question.

As used herein, the expressions “A, B, and C,” “A, B, or C,” “A, B, and/or C,” or “at least one of A, B, and C,” “at least one of A, B, or C,” “at least one of A, B, and/or C,” “at least one selected from A, B, and C,” “at least one selected from A, B, or C,” “at least one selected from A, B, and/or C,” etc., may mean each of the listed items or all possible combinations of the listed items. For example, “at least one selected from A and B” may refer to: (1) A; (2) at least one of A; (3) B; (4) at least one of B; (5) at least one of A and at least one of B; (6) at least one of A and B; (7) at least one of B and A; and (8) both A and B.

As used herein, the expression “˜based on” is used to describe one or more factors affecting the decision, act of judgment, or action described in the phrase or sentence containing the expression, and this expression does not exclude additional factors influencing the decision, or act or action of judgment.

As used herein, the expression “a component (e.g., a first component) is “connected” or “coupled” to another component (e.g., a second component)” may mean that the component is not only directly connected or coupled to another component, but is also connected or coupled to another component via a new another component (e.g., a third component).

As used herein, the expression “configured to ˜” may mean “set to ˜,” “have the ability to ˜,” “modified to ˜,” “made to ˜,” “capable of ˜,” etc., according to the context. The corresponding expression is not limited to the meaning of “specifically designed in hardware.” For example, a processor configured to perform a specific operation may mean a generic-purpose processor that can perform the specific operation by executing software.

Unless defined otherwise, all terms (including technical and scientific terms) used in the present invention have the same meaning as meanings commonly understood by those skilled in the art to which the present invention pertains. In addition, terms defined in generally used dictionaries are not ideally or excessively interpreted unless they are specifically defined clearly.

In this specification, a computer means all kinds of hardware devices including at least one processor, and can be understood as including a software configuration which is operated in the corresponding hardware device according to the embodiment. For example, the computer may be understood as a meaning including all of smart phones, tablet PCs, desktops, laptops, and user clients and applications running on each device, but is not limited thereto.

Hereinafter, embodiments of the present invention will be described in detail with reference to the accompanying drawings.

Each step described in this specification is described as being performed by the computer, but subjects of each step are not limited thereto, and according to embodiments, at least some of each steps can also be performed on different devices.

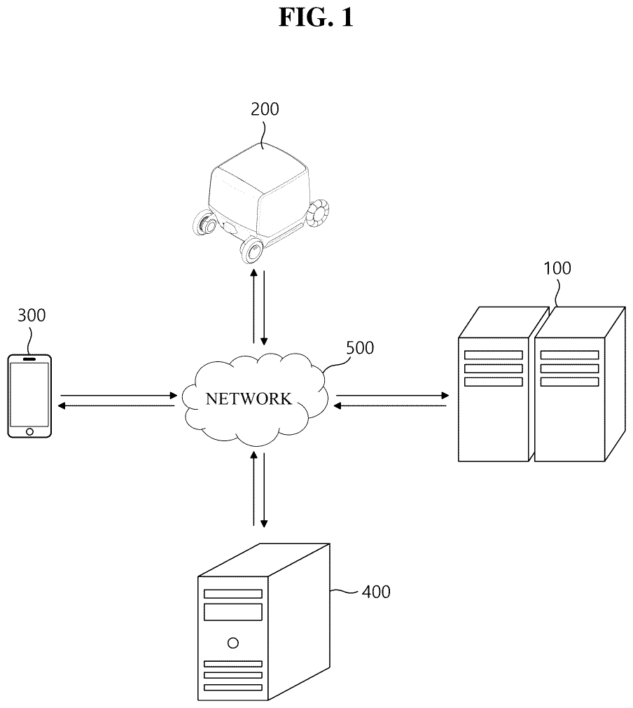

FIG. 1 is a diagram illustrating a goods delivery system using an unmanned delivery robot according to an embodiment of the present invention.

Referring to FIG. 1, the goods delivery system using an unmanned delivery robot according to an embodiment of the present invention may include a server 100, an unmanned delivery robot 200, a terminal 300, an external server 400, and a network 500.

Here, the goods delivery system using an unmanned delivery robot illustrated in FIG. 1 is according to an embodiment, and components of the autonomous driving system are not limited to the embodiment illustrated in FIG. 1, and may be added, changed, or omitted as necessary.

In an embodiment, the server 100 may perform a goods delivery method using an unmanned delivery robot by controlling an operation of an unmanned delivery robot 200.

In various embodiments, when the server 100 acquires delivery information for a predetermined space, the server 100 may control the operation of the unmanned delivery robot 200 based on the delivery information so that goods corresponding to the delivery information are delivered to a delivery point through the unmanned delivery robot 200.

Here, the predetermined space may mean any space such as a building or an apartment complex where goods delivery such as a delivery service, quick delivery, or food delivery is required, but is not limited thereto.

In addition, the present invention describes that the server 100 performs delivery work of delivering goods by controlling the operation of the unmanned delivery robot 200, but is not limited thereto. In some cases, as a request for goods delivery and/or goods return is acquired from a user, the server 100 may control the operation of the unmanned delivery robot 200 so that the goods to be delivered to/returned from the user may be implemented to be transported to a goods delivery/return point.

In an embodiment, the unmanned delivery robot 200 is placed in the predetermined space and may perform the goods delivery work by operating the unmanned delivery robot 200 according to a control command acquired from the server 100.

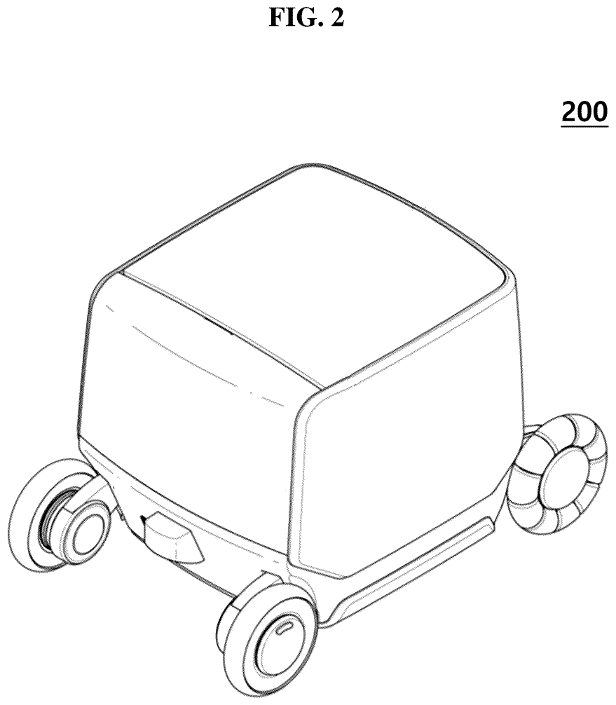

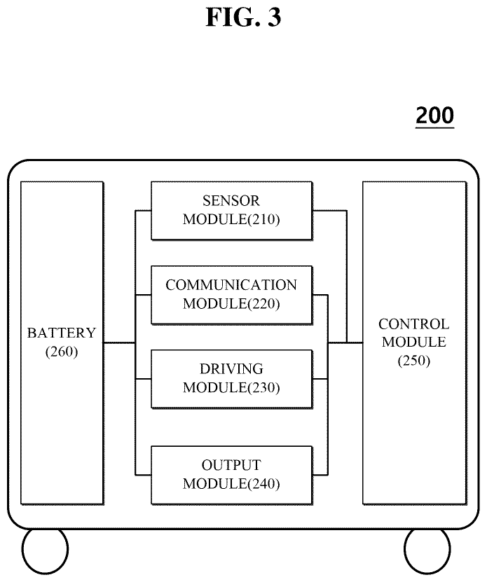

More specifically, referring to FIGS. 2 and 3, the unmanned delivery robot 200 may include, but is not limited to, a sensor module 210, a communication module 220, a driving module 230, an output module 240, a control module 250, and a battery 260.

First, the sensor module 210 may collect information about the unmanned delivery robot 200 and/or the surrounding environment of the unmanned delivery robot 200. For example, the sensor module 210 may include, but is not limited to, a weight measurement sensor that measures a weight of goods loaded onto the unmanned delivery robot 200, a camera sensor that scans the surrounding environment of the unmanned delivery robot 200, a lidar sensor and a radar sensor, and an inertial measurement sensor that measures inertial information about the unmanned delivery robot 200.

Next, the communication module 220 may be connected to the server 100 through the network 500 and perform communication with the server 100. For example, a control command may be acquired from the server 100 through the communication module 220, or sensor data measured from the sensor module 210 may be provided to the server 100 through the communication module 220. For example, as the communication module 220, various modules such as a wireless fidelity (Wi-Fi) module, a Bluetooth module, a cellular module (long term evolution/5^{th} generation (LTE/5G) module), a radio frequency (RF) module, a ZigBee module, and a narrowband Internet of Things (NB-IoT) module may be applied.

Next, the driving module 230 may move the unmanned delivery robot 200 by operating under the control of the control module 250 described below. For example, the driving module 230 may include a wheel, a moving motor that rotates the wheel, and a motor driving driver that controls the motor, but is not limited thereto.

Next, the output module 240 may output a notification of the control module 250 described below. For example, the output module 240 may include a speaker that outputs a notification in a voice form, but is not limited thereto, and may include various components such as a display.

Next, the control module 250 may control operations of various components included in the unmanned delivery robot 200 according to the control command acquired from the server 100.

Finally, the battery 260 may supply power for driving various components included in the unmanned delivery robot 200.

Referring back to FIG. 1, in an embodiment, the terminal 300 may be connected to the server 100 through the network 500, and may receive various types of information related to the goods delivery method using an unmanned delivery robot from the server 100, or provide various types of information necessary for the server 100 to perform the goods delivery method using an unmanned delivery robot.

For example, the user may receive a status of the delivery task (e.g., delivery state, location, whether delivery is completed (photo or video, etc.)) performed by the unmanned delivery robot 200 through text messages, KakaoTalk, application notifications, etc., through the terminal 300 (more specifically, through an application executed through the terminal 300).

In various embodiments, the user may intervene in the delivery task performed by the unmanned delivery robot 200 through the terminal 300. For example, the user may control stopping and starting of the delivery work of the unmanned delivery robot 200 or change the delivery point through the terminal 300. In addition, the user may determine a method (e.g., face-to-face, non-face-to-face, etc.) of receiving goods delivered through the terminal 300. In addition, users may request delivery caution for goods, which are likely to be damaged or are sensitive, through terminal 300 so that the speed and direction control of the unmanned delivery robot 200 is performed more gently to induce safer delivery.

Here, the terminal 300 may refer to any type of entity(s) in the system that has a mechanism for communication with the server 100. For example, the terminal 300 may include a personal computer (PC), a notebook, a mobile terminal, a smart phone, a tablet personal computer (tablet PC), a wearable device, etc., and may include any type of terminal that may access wired/wireless networks. In addition, the terminal 300 may include any computing device implemented by at least one of an agent, an application programming interface (API), and a plug-in. In addition, the terminal 300 may include an application source and/or a client application.

In addition, here, the network 500 may be a connection structure capable of exchanging information between respective nodes such as a plurality of terminals and servers. For example, the network 500 may include a local area network (LAN), a wide area network (WAN), the Internet (World Wide Web (WWW)), a wired/wireless data communication network, a telephone network, a wired/wireless television communication network, a controller area network (CAN), Ethernet, or the like.

Examples of the wireless data communication network may include 3G, 4G, 5G, 3^{rd} Generation Partnership Project (3GPP), 5^{th} Generation Partnership Project (5GPP), long term evolution (LTE), world interoperability for microwave access (WiMAX), Wi-Fi, Internet, a local area network (LAN), a wireless local area network (WLAN), a wide area network (WAN), a personal area network (PAN), radio frequency, a Bluetooth network, a near-field communication (NFC) network, a satellite broadcast network, an analog broadcast network, a digital multimedia broadcasting (DMB) network, and the like, but are not limited thereto.

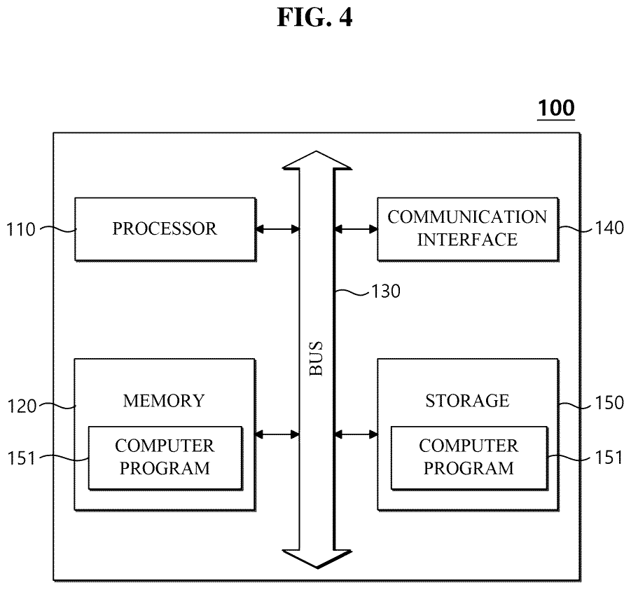

In an embodiment, the external server 400 may be connected to the server 100 through the network 500, and may store and manage information and data required for the server 100 to perform various processes, or may receive and store and manage information and data generated as the server 100 performs various processes. For example, the external server 400 may be a storage server separately provided outside the server 100. As another example, the external server 400 may be a goods delivery company server that stores and manages the delivery information, but is not limited thereto. Hereinafter, a hardware configuration of the server 100 that performs the goods delivery method using an unmanned delivery robot will be described with reference to FIG. 4.

FIG. 4 is a diagram illustrating a hardware configuration of a server according to another embodiment of the present invention.

Referring to FIG. 4, according to various embodiments, the server 100 according to an embodiment of the present invention may include one or more processors 110, a memory 120 that loads a computer program 151 executed by the processor 110, a bus 130, a communication interface 140, and a storage 150 that stores the computer program 151. Here, only the components related to the embodiment of the present invention are illustrated in FIG. 4. Accordingly, those skilled in the art to which the present invention pertains may understand that other general-purpose components other than those illustrated in FIG. 4 may be further included.

The processor 110 controls an overall operation of each component of the server 100. The processor 110 may be configured to include a central processing unit (CPU), a micro processor unit (MPU), a micro controller unit (MCU), a graphic processing unit (GPU), or any type of processor well known in the art of the present invention.

In addition, the processor 110 may perform calculations on at least one application or program for executing the method according to the embodiments of the present invention, and the server 100 may include one or more processors.

In various embodiments, the processor 110 may further include a random access memory (RAM) (not illustrated) and a read-only memory (ROM) (not illustrated) for temporarily and/or permanently storing signals (or data) processed in the processor 110. In addition, the processor 110 may be implemented in the form of a system-on-chip (SoC) including at least one of a graphics processing unit, a RAM, and a ROM.

The memory 120 stores various types of data, commands, and/or information. The memory 120 may load the computer program 151 from the storage 150 to execute methods/operations according to various embodiments of the present invention. When the computer program 151 is loaded into the memory 120, the processor 110 may perform the method/operation by executing one or more instructions constituting the computer program 151. The memory 120 may be implemented as a volatile memory such as a random access memory (RAM), but the technical scope of the present invention is not limited thereto.

The bus 130 provides a communication function between the components of the server 100. The bus 130 may be implemented as various types of buses, such as an address bus, a data bus, and a control bus.

The communication interface 140 supports wired/wireless Internet communication of the server 100. In addition, the communication interface 140 may support various communication manners other than the Internet communication. To this end, the communication interface 140 may be configured to include a communication module well known in the art of the present invention. In some embodiments, the communication interface 140 may be omitted.

The storage 150 may non-temporarily store the computer program 151. When performing the goods delivery process using the unmanned delivery robot through the server 100, the storage 150 may store various types of information necessary to provide the goods delivery process using the unmanned delivery robot.

The storage 150 may include a nonvolatile memory, such as a ROM, an erasable programmable ROM (EPROM), an electrically erasable programmable ROM (EEPROM), and a flash memory, a hard disk, a removable disk, or any well-known computer-readable recording medium in the art to which the present invention pertains.

The computer program 151 may include one or more instructions to cause the processor 110 to perform methods/operations according to various embodiments of the present invention when loaded into the memory 120. That is, the processor 110 may perform the method/operation according to various embodiments of the present invention by executing the one or more instructions.

In an embodiment, the computer program 151 may include one or more instructions for performing the goods delivery method using an unmanned delivery robot that includes acquiring the delivery information for the predetermined space and controlling the operation of the unmanned delivery robot based on the acquired delivery information to deliver the goods corresponding to the delivery information to the delivery point through the unmanned delivery robot.

Operations of the method or algorithm described with reference to the embodiment of the present invention may be directly implemented in hardware, in software modules executed by hardware, or in a combination thereof. The software module may reside in a random access memory (RAM), a read only memory (ROM), an erasable programmable ROM (EPROM), an electrically erasable programmable ROM (EEPROM), a flash memory, a hard disk, a removable disk, a compact disc read-only memory (CD-ROM), or in any form of computer-readable recording media known in the art to which the invention pertains.

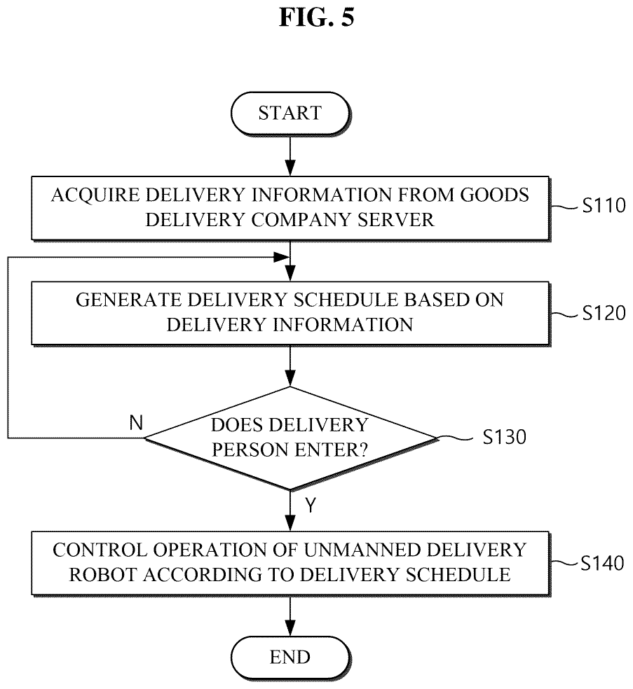

The components of the present invention may be embodied as a program (or application) and stored in media for execution in combination with a computer which is hardware. The components of the present invention may be executed in software programming or software elements, and similarly, embodiments may be realized in a programming or scripting language such as C, C++, Java, and assembler, including various algorithms implemented in a combination of data structures, processes, routines, or other programming constructions. Functional aspects may be implemented in algorithms executed on one or more processors. Hereinafter, the goods delivery method using an unmanned delivery robot performed by the server 100 will be described with reference to FIGS. 5 to 10.

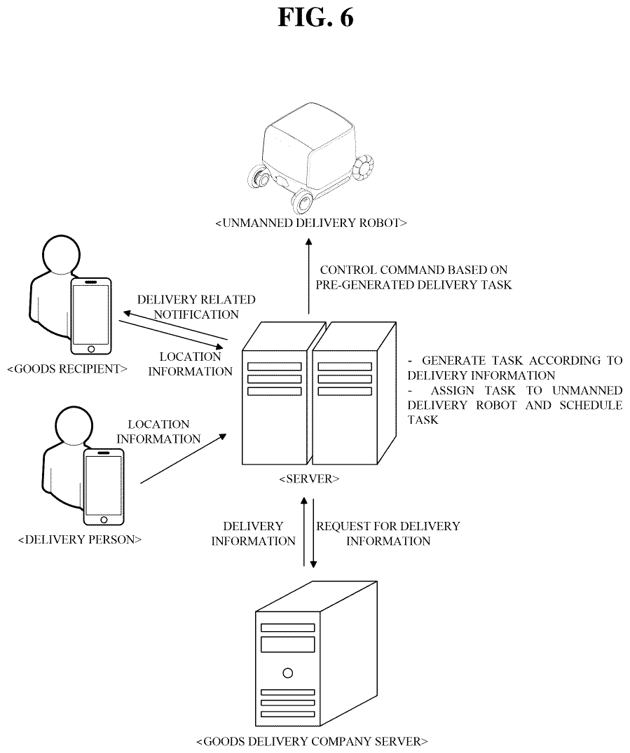

FIG. 5 is a flowchart for describing a goods delivery method using an unmanned delivery robot according to a first embodiment, and FIG. 6 is a flowchart for describing a process of controlling the unmanned delivery robot to deliver goods according to the first embodiment.

Referring to FIGS. 5 and 6, the server 100 receives delivery information planned in advance, for example, delivery information generated and stored in advance according to an order through an online market, from a delivery company to generate and assign a delivery task in advance, and controls the operation of the unmanned delivery robot 200 based on the delivery information, thereby delivering goods through the unmanned delivery robot 200.

In operation S110, the server 100 may acquire delivery information for a predetermined space.

In various embodiments, the server 100 may be connected to a goods delivery company server (e.g., a delivery company server) through the network 500, and may acquire the delivery information for the predetermined space from the goods delivery company server.

Here, the delivery information acquired from the goods delivery company server may include, but is not limited to, information about one or more goods (e.g., type, size, and number of goods, delivery point, recipient information) scheduled to be delivered to the predetermined space and information about a delivery person for delivering one or more goods.

In various embodiments, the server 100 may acquire the delivery information for the predetermined space from the goods delivery company server every preset period (e.g., every evening at 6 p.m.), but is not limited thereto, and may acquire the delivery information for the predetermined space from the goods delivery company server whenever the delivery information for the predetermined space is generated.

In operation S120, the server 100 may generate the delivery task based on the delivery information acquired through operation S110.

In various embodiments, the server 100 may generate a delivery task for delivering specific goods included in the delivery information to a specific delivery point based on the delivery information acquired from the goods delivery company server.

In various embodiments, when there are the plurality of unmanned delivery robots 200 placed in the predetermined space, the server 100 may assign the delivery task generated in response to the delivery information to at least one of the plurality of unmanned delivery robots 200.

In operation S130, the server 100 may determine an entry of a delivery person into the predetermined space.

For example, the server 100 may determine whether a specific delivery person enters a predetermined space based on location information (e.g., GPS information) acquired from the terminal 300 of the specific delivery person.

As another example, the server 100 may provide a user interface (UI) that provides a goods delivery service to the terminal 300 of the specific delivery person, and may determine whether the specific delivery person enters the predetermined space by acquiring a user input corresponding to entering the predetermined space through the UI.

As another example, the server 100 may analyze an image generated by capturing a vehicle attempting to enter a predetermined space through a camera installed at an entrance of the predetermined space to identify a vehicle number, and determine an entry of a delivery person corresponding to the vehicle number based on the identified vehicle number.

At operation S140, when the server 100 determines that the specific delivery person has entered the predetermined space through operation S130, the server 100 may select a delivery task generated based on delivery information including information about a specific delivery person and/or information about goods to be delivered by the specific delivery person among a plurality of pre-generated delivery tasks, generate a control command according to the selected delivery task, and control the operation of the unmanned delivery robot 200 to which the corresponding delivery task is assigned according to the control command.

In this case, the server 100 may control the operation of the unmanned delivery robot 200 in response to the goods to be delivered being loaded onto the unmanned delivery robot 200.

Here, the server 100 may determine whether goods are loaded based on sensor data collected through the sensor module 210 included in the unmanned delivery robot 200. For example, the server 100 may analyze image data captured by a camera included in the unmanned delivery robot 200 to determine whether goods are loaded, but the present invention is not limited thereto. Therefore, various methods such as a method in which the server 100 determines whether goods are loaded based on the weight value measured by the weight measurement sensor included in the unmanned delivery robot 200 may be applied.

In addition, here, the operation of loading the goods onto the unmanned delivery robot 200 may be implemented in the form that the delivery person directly loads goods onto a loading box included in the unmanned delivery robot 200.

Meanwhile, when there are many delivery tasks to be processed in a predetermined space and all the unmanned delivery robots 200 are performing the delivery tasks, there is a problem that, when a delivery person wants to directly load goods onto the unmanned delivery robot 200 as described above, the delivery person should wait the unmanned delivery robot 200 that will deliver the goods of the delivery person until the unmanned delivery robot 200 comes to a goods loading space, which leads to the problem of delaying time even more than delivering goods directly.

Considering this, a temporary goods storage space for temporarily storing goods to be delivered is provided in a predetermined space, so that delivery men store the goods to be delivered in the temporary goods storage space, and the unmanned delivery robot 200 may be implemented to pick (e.g., through a picking module in the form of a robot arm included in the unmanned delivery robot 200) and load the goods stored in the temporary goods storage space.

To this end, the goods stored in the goods temporary storage space may have separate identification codes (e.g., barcodes, QR codes, etc.) printed thereon for identification, and the unmanned delivery robot 200 may scan the identification codes printed on the goods to find the goods to be delivered and pick, load, and deliver the goods.

In various embodiments, the server 100 may control the operation of the unmanned delivery robot 200 according to a control command generated in response to a delivery task, and when it is determined that the goods loaded onto the unmanned delivery robot 200 are not goods corresponding to the delivery task, may output a notification.

More specifically, the server 100 may control an operation of a specific unmanned delivery robot 200 to which a specific delivery task is assigned according to a control command generated in response to the specific delivery task.

In this case, when goods are loaded onto a specific unmanned delivery robot 200, the server 100 may determine whether the goods loaded onto the specific unmanned delivery robot 200 matches the goods corresponding to the specific delivery task, and when the goods loaded onto the specific unmanned delivery robot 200 do not match the goods corresponding to the specific delivery task, the server 100 may control a notification to be output to guide confirmation of the goods through the output module 240 included in the specific unmanned delivery robot.

Here, the server 100 may determine whether the goods loaded onto the specific unmanned delivery robot 200 match the goods corresponding to the specific delivery task based on sensor data collected through the sensor module 210 included in the specific unmanned delivery robot 200.

For example, the server 100 may analyze the image data captured by the camera included in the unmanned delivery robot 200 to extract one or more features of the goods loaded onto the specific unmanned delivery robot 200, calculate a similarity between one or more features and a reference feature (e.g., a preset feature for goods corresponding to specific delivery information), and determine whether the goods loaded onto the specific unmanned delivery robot 200 match the goods corresponding to the specific delivery task based on the calculated similarity.

As another example, the server 100 may measure a weight value of the goods loaded onto the specific unmanned delivery robot 200 through the weight measurement sensor included in the specific unmanned delivery robot 200, and compare the weight values with a reference weight value (e.g., a weight value of goods corresponding to specific delivery information) to determine whether the loaded goods match the goods corresponding to the specific delivery task. However, the present invention is not limited thereto.

In various embodiments, when delivery to a specific delivery point for specific goods is completed, the server may provide a notification for guiding delivery completion to the terminal 300 of the recipient corresponding to a specific delivery point.

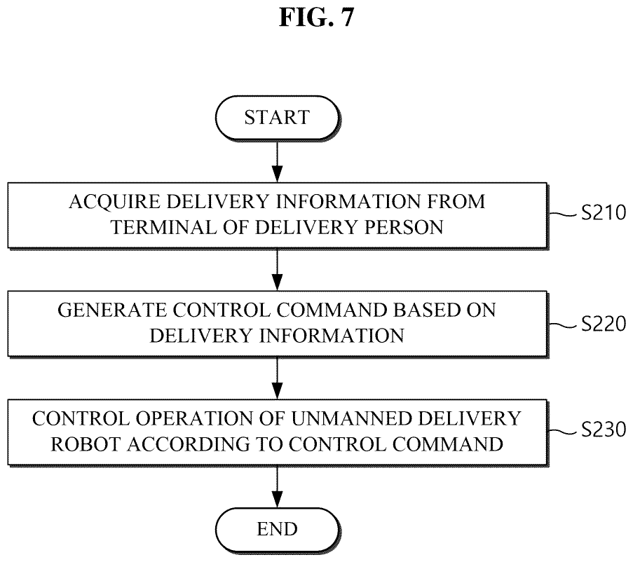

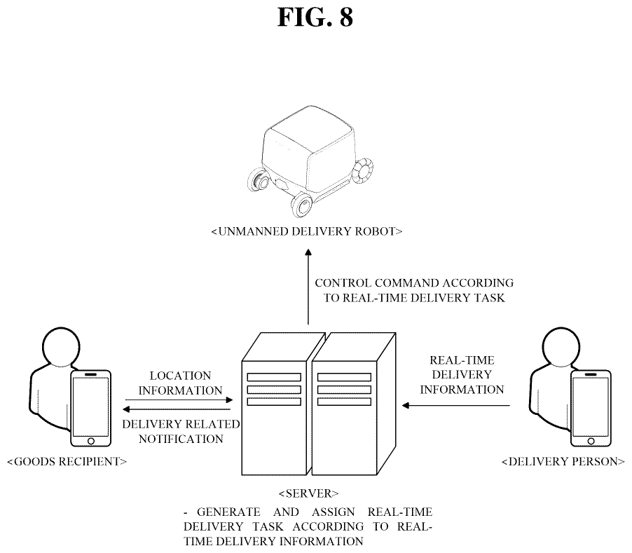

FIG. 7 is a flowchart for describing a goods delivery method using an unmanned delivery robot according to a second embodiment, and FIG. 8 is a flowchart for describing a process of controlling the unmanned delivery robot to deliver goods according to the second embodiment.

Referring to FIGS. 7 and 8, the server 100 controls the operation of the unmanned delivery robot 200 in response to delivery information generated in real time, such as delivery information, which is not planned in advance, such as goods delivery through a quick service, mart shopping, goods delivery through a same-day delivery service such as Market Kurly and Rocket Fresh, and food delivery, thereby delivering goods through the unmanned delivery robot 200.

Referring to FIGS. 7 and 8, in operation S210, the server 100 may acquire delivery information from a specific delivery person who has entered a predetermined space.

In various embodiments, when the server 100 determines that the specific delivery person has entered the predetermined space, the server 100 may request the delivery information to the terminal 300 of the specific delivery person, and thus, obtain the delivery information for the predetermined space from the terminal 300 of the specific delivery person.

Here, since a delivery person for delivering goods has already been specified, the delivery information acquired from the terminal 300 of the specific delivery person may include only information about one or more goods scheduled to be delivered to the predetermined space (e.g., type, size, number of goods, delivery point, recipient information), but the present invention is not limited thereto.

In addition, the operation of determining, by the server 100, whether the specific delivery person enters the predetermined space may be implemented in a form identical to or similar to the method performed in operation S130 of FIG. 5, but is not limited thereto.

In operation S120, the server 100 may generate the control command based on the delivery information acquired through operation S210.

In various embodiments, when the plurality of unmanned delivery robots 200 are placed in the predetermined space, the server 100 may determine the number of unmanned delivery robots 200 to be controlled based on attributes (e.g., number of goods, type, delivery point, weight, size, etc.) of the goods to be delivered included in the delivery information, and generate a control command to control the operation of the determined number of unmanned delivery robots 200.

In various embodiments, when the server 100 wants to deliver goods to a plurality of different delivery points using one unmanned delivery robot 200 based on the acquired delivery information, the server 100 may generate a movement path connecting the plurality of different delivery points based on at least one of a movement time and a movement distance, and generate a control command to control one unmanned delivery robot 200 to move along the generated movement path.

In various embodiments, the server 100 may determine selection criteria of the movement path based on the amount of goods to be delivered in a predetermined space, and generate the movement path according to the determined selection criteria.

For example, when the amount of delivery goods to be processed in the predetermined space exceeds a reference amount, the server 100 may determine the selection criteria of the movement path as “movement time” so that faster delivery work may be performed, and determine a candidate movement path that is expected to take the shortest time among a plurality of candidate movement paths connecting the plurality of different delivery points as the movement path of the unmanned delivery robot 200.

Meanwhile, when the amount of delivery goods to be processed in the predetermined space is less than the reference amount, the server 100 may determine the candidate movement path that has the shortest distance among the plurality of candidate movement paths connecting the plurality of different delivery points as the movement path of the unmanned delivery robot 200 by considering energy efficiency rather than faster delivery work.

In various embodiments, the server 100 may generate the movement path of the unmanned delivery robot 200 using the movement time and movement distance.

More specifically, first, when server 100 wants to deliver goods to the plurality of different delivery points using one unmanned delivery robot 200, the server 100 may set the plurality of candidate movement paths by defining all cases connecting the plurality of different delivery points as the candidate movement paths. After that, server 100 can calculate movement time scores and movement distance scores for each of the plurality of candidate movement paths.

Thereafter, the server 100 may calculate movement time scores and movement distance scores for each of the plurality of candidate movement paths.

For example, the server 100 may sort candidate movement paths in ascending order starting from the candidate movement path with the shortest movement time, and assign a movement time score having a size inversely proportional to the sorted order.

In this case, when inter-floor movement between two different delivery points is required for a specific candidate path, the server 100 may adjust the movement time for the specific candidate path based on a location of an elevator for the inter-floor movement between the two delivery points, and when the order changes accordingly, adjust the movement time score for the specific candidate path.

In addition, the server 100 may sequentially sort candidate movement paths in ascending order starting from the candidate movement path with the shortest movement distance, and assign the movement distance score having a size inversely proportional to the sorted order.

Thereafter, the server 100 may select the candidate movement path with the highest sum of movement time score and movement distance score among the plurality of candidate movement paths as the final movement path.

In operation S230, the server 100 may control the operation of the unmanned delivery robot 200 based on the control command generated through operation S220.

In various embodiments, when the server 100 wants to deliver specific goods to a specific delivery point through the specific unmanned delivery robot 200 based on the delivery information, the server 100 may control the operation of the specific unmanned delivery robot 200 by considering the movement paths of the unmanned delivery robots moving according to the pre-generated delivery tasks.

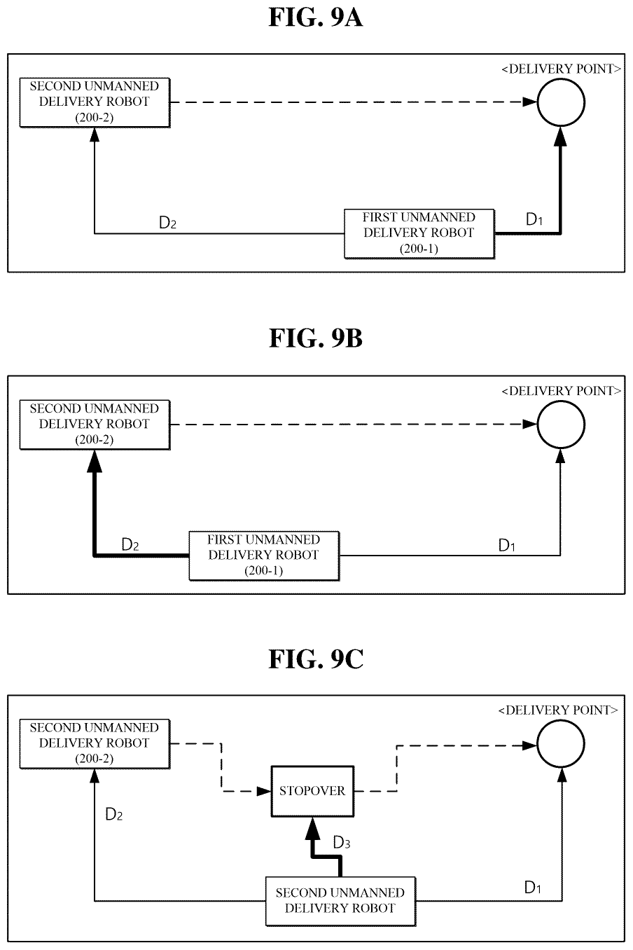

More specifically, referring to FIGS. 9A to 9C, first, when the server 100 wants to deliver specific goods to a specific delivery point based on delivery information, the server 100 may control the first unmanned delivery robot 200-1, which is currently in a standby state, to deliver the specific goods to the specific delivery point through the first unmanned delivery robot 200-1.

Thereafter, when the first unmanned delivery robot 200-1 is moving to the specific delivery point to be delivered or there is a second unmanned delivery robot 200-2 that is scheduled to move, the server 100 may compare a first distance D₁ from a current location of the first unmanned delivery robot 200 to the specific delivery point and a second distance D₂ from the current location of the first unmanned delivery robot 200 to a location of the second unmanned delivery robot 200-2 by considering the movement paths of the unmanned delivery robots that are moving according to the pre-generated delivery tasks. In this case, as illustrated in FIG. 9A, when the first distance D₁ is shorter than the second distance D₂, the server 100 may control the first unmanned delivery robot 200 to directly deliver the specific goods to the specific delivery point.

Meanwhile, as illustrated in FIG. 9B, when the second distance D₂ is shorter than the first distance D₁, the server 100 may control the first unmanned delivery robot 200 to move to the location of the second unmanned delivery robot 200-2 and deliver the specific goods to the second unmanned delivery robot 200-2, and control the second unmanned delivery robot 200-2 to deliver existing goods and specific goods together to the specific delivery point.

In various embodiments, as illustrated in FIG. 9C, when a stopover exists on the movement path of the first unmanned delivery robot 200-1 and/or the movement path of the second unmanned delivery robot 200-2, the server 100 may calculate the first distance D₁ from the current location of the first unmanned delivery robot 200-1 to the specific delivery point, the second distance D₂ from the current location of the first unmanned delivery robot 200-1 to the location of the second unmanned delivery robot 200-2, and a third distance D₃ from the current location of the first unmanned delivery robot 200 to the stopover.

In this case, when the third distance D₃ from the current location of the first unmanned delivery robot 200-1 to the stopover is the shortest distance, the server 100 may control the first unmanned delivery robot 200-1 to deliver specific goods to the stopover, and control the movement path of the second unmanned delivery robot 200-2 to change so that it picks up specific goods via the stopover and then moves to the specific delivery point.

Here, the stopover may be a preset space, for example, the elevator for the inter-floor movement and/or an area near the elevator may be a stopover.

In various embodiments, the server 100 may control the unmanned delivery robot 200 to move along the movement path, and when it is determined that the inter-floor movement via an elevator is necessary based on the movement path, transmit a control request requesting to control the operation of the elevator to an elevator control server for controlling the elevator at the time at which the unmanned delivery robot arrives at the elevator.

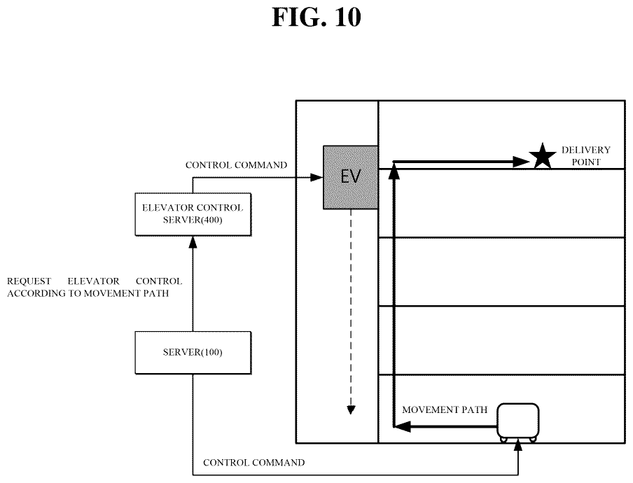

More specifically, referring to FIG. 10, the server 100 may control the specific unmanned delivery robot 200 to move along the movement path by transmitting the control command to the specific unmanned delivery robot 200 located on a specific floor.

In this case, when the server 100 determines that the specific unmanned delivery robot 200 needs to move from the specific floor to another floor based on the movement path corresponding to the specific unmanned delivery robot 200, the server 100 may transmit an elevator control request according to the movement path to the elevator control server 400.

Here, the elevator control request provided to the elevator control server 400 may include information about the time at which the specific unmanned delivery robot 200 wants to use the elevator (e.g., the time at which the specific unmanned delivery robot 200 arrives at the elevator), so the elevator control server 400 may control the elevator to arrive at the specific floor at the time at which the specific unmanned delivery robot 200 wants to use the elevator.

Meanwhile, when the server 100 acquires an elevator control rejection at a first time from the elevator control server 400 in response to transmitting the elevator control request requesting the elevator control to the elevator control server 400 at the first time, the server 100 may query the elevator control server 400 for the earliest time at which the elevator control is possible based on the first time, and when a second time is designated as the time at which the elevator control is possible from the elevator control server 400, the server 100 may control the specific unmanned delivery robot 200 to move to the elevator at the second time.

In this case, when a time difference between the first time, which is the initial time of wanting to use the elevator, and the second time, which is designated as the point where elevator control is possible from the elevator control server 400, is within a reference time value, the server 100 controls the specific unmanned delivery robot 200 to move to the elevator up to the first time, but when the difference between the first time and the second time exceeds the reference time value, the server 100 controls the specific unmanned delivery robot 200 to move to the elevator at the second time, so the server 100 may correct the movement path preset for the specific unmanned delivery robot 200.

For example, the server 100 may correct the movement path so that the specific unmanned delivery robot 200 performs additional delivery during the period of time that occurs when the time at which the specific unmanned delivery robot 200 moves to the elevator changes from the first time to the second time, or correct the movement path so that the battery is charged during the corresponding time of period, but the present invention is not limited thereto.

In various embodiments, when the server 100 wants to deliver the specific goods to the specific delivery point based on the delivery information, the server 100 may determine whether the recipient of the specific goods is absent based on the location information acquired from the terminal 300 of the recipient of the specific goods, and when it is determined that the recipient of the specific goods is absent, the server 100 may control the unmanned delivery robot 200 to deliver the specific goods to a preset consignment delivery point.

In various embodiments, when the server 100 determines that the unmanned delivery robot 200 has arrived at the delivery point according to the control command, the server 100 may measure the weight value through the weight measurement sensor of the unmanned delivery robot 200, and when the change in weight value is detected based on the weight value measured through the weight measurement sensor, the server 100 may determine that the goods loaded on the unmanned delivery robot 200 have been received, and control the unmanned delivery robot 200 to return to a pre-set return point.

In this case, for the specific unmanned delivery robot 200 that has moved to the specific delivery point to deliver the specific goods, when the change in weight value exceeding the weight value of the specific goods is detected through the weight measurement sensor included in the specific unmanned delivery robot 200, the server 100 may control the warning notification to be output through the output module 240 included in the specific unmanned delivery robot 200.

In other words, the server 100 may prevent a recipient from receiving the wrong goods or illegally receiving goods of someone other than his/her own goods through the change in weight value of the goods.

In various embodiments, for the specific unmanned delivery robot 200 that has moved to the specific delivery point to deliver the specific goods, when the change in weight value is not detected until the reference time has elapsed through the weight measurement sensor included in the specific unmanned delivery robot 200, the server 100 may control the specific unmanned delivery robot 200 to return to the preset return point, thereby preventing the specific unmanned delivery robot 200 from waiting indefinitely as the goods loaded onto the specific unmanned delivery robot 200 are not received.

In this case, the reference time may be the preset waiting time, which may be a fixed time value, but is not limited thereto, and may be a value that is dynamically determined based on the attributes (e.g., size, type, weight, etc.) of the loaded goods (or goods to be delivered).

The above-described goods delivery method using an unmanned delivery robot was described with reference to the flowcharts illustrated in the drawings. For a simple description, the goods delivery method using an unmanned delivery robot has been described by showing a series of blocks, but the present invention is not limited to the order of the blocks, and some blocks may be performed in an order different from that shown and performed in the present specification, or may be performed concurrently. In addition, new blocks not described in the present specification and drawings may be added, or some blocks may be omitted or changed.

According to various embodiments of the present invention, by placing the unmanned delivery robot in the predetermined space, such as a large building or an apartment complex and performing the goods delivery work using the unmanned delivery robot, it is possible to reduce the burden on the delivery worker due to the delivery work and more efficiently perform the delivery work.

Effects of the present invention are not limited to the effects described above, and other effects that are not mentioned may be obviously understood by those skilled in the art from the following description.

Although exemplary embodiments of the present invention have been described with reference to the accompanying drawings, those skilled in the art will understand that various modifications and alterations may be made without departing from the spirit or essential feature of the present invention. Therefore, it is to be understood that the exemplary embodiments described hereinabove are illustrative rather than being restrictive in all aspects.

What is claimed is:

1. A goods delivery system using an unmanned delivery robot, comprising:
an unmanned delivery robot placed in a predetermined space; and
a server that controls an operation of the unmanned delivery robot,
wherein the server controls the operation of the unmanned delivery robot based on delivery information for the predetermined space to allow goods corresponding to the delivery information to be delivered to a delivery point through the unmanned delivery robot.

2. The goods delivery system of claim 1, wherein, when the server acquires delivery information including information about one or more goods scheduled to be delivered to the predetermined space and information about a delivery person for delivering the one or more goods from a goods delivery company server, the server generates a delivery task for the one or more goods based on the acquired delivery information, and
when the delivery person for delivering the one or more goods enters the predetermined space, the server generates a control command according to the generated delivery task, and controls the operation of the unmanned delivery robot according to the generated control command.

3. The goods delivery system of claim 2, wherein the server controls the operation of the unmanned delivery robot according to the generated control command and determines whether goods loaded onto the unmanned delivery robot match the goods corresponding to the generated delivery task, and
when the goods loaded onto the unmanned delivery robot do not match the goods corresponding to the generated delivery task, the server performs control to output a notification guiding a confirmation of the goods through an output module included in the unmanned delivery robot.

4. The goods delivery system of claim 1, wherein, when the server acquires delivery information from a specific delivery person who enters the predetermined space, the server generates a control command according to the acquired delivery information and controls the operation of the unmanned delivery robot according to the generated control command.

5. The goods delivery system of claim 4, wherein the server determines the number of unmanned delivery robots to be controlled based on attributes of the goods to be delivered included in the acquired delivery information, the attributes of the goods including at least one of the number, type, delivery point, weight, and size of the goods.

6. The goods delivery system of claim 4, wherein, when specific goods are delivered to a specific delivery point based on the acquired delivery information, the server controls a first unmanned delivery robot to deliver the specific goods to the specific delivery point through the first unmanned delivery robot, and
when there is a second unmanned delivery robot moving to the specific delivery point based on a pre-generated delivery task, the server controls the first unmanned delivery robot to deliver the specific goods to the second unmanned delivery robot and then return to a preset return point.

7. The goods delivery system of claim 4, wherein, when goods are delivered to a plurality of different delivery points using one unmanned delivery robot based on the acquired delivery information, the server generates a movement path connecting the plurality of different delivery points based on at least one of a movement time and a movement distance, and controls the one unmanned delivery robot to move along the generated movement path.

8. The goods delivery system of claim 7, wherein, when the server determines that inter-floor movement via an elevator is necessary based on the generated movement path, the server transmits a control request requesting to control an operation of the elevator to an elevator control server for controlling the elevator at a time the unmanned delivery robot arrives at the elevator.

9. The goods delivery system of claim 4, wherein, when specific goods are delivered to a specific delivery point based on the acquired delivery information, the server determines whether a recipient of the specific goods is absent based on location information acquired from a terminal of the recipient of the specific goods, and
when it is determined that the recipient of the specific goods is absent, the server controls the unmanned delivery robot to deliver the specific goods from the recipient of the specific goods to a preset consignment delivery point.

10. A goods delivery method using an unmanned delivery robot, which is performed by a goods delivery system including the unmanned delivery robot placed in a predetermined space and a server for controlling an operation of the unmanned delivery robot, the method comprising:
acquiring, by the server, delivery information for the predetermined space; and
controlling, by the server, the operation of the unmanned delivery robot based on the acquired delivery information to allow goods corresponding to the delivery information to be delivered to a delivery point through the unmanned delivery robot.
